(19) United States
(12) Patent Application Publication
(10) Pub. No.: US 2020/0208873 A1
(43) Pub. Date: Jul. 2, 2020

(54) WET SAW WATER PAN WATER HEATER

(71) Applicant: Chad Lane, Colorado Springs, CO (US)

(72) Inventor: Chad Lane, Colorado Springs, CO (US)

(21) Appl. No.: 15/816,255

(22) Filed: Nov. 17, 2017

(51) Int. Cl. F24H 1/06; B23D 59/02; B28D 7/02

(52) U.S. Cl. CPC F24H 1/06; F24H 1/101; B28D 7/02; B23D 59/02

(57) ABSTRACT

A saw water pan water heater may comprise a base plate, at least one coil electrically coupled to the base plate, a power source electrically coupled to the base plate, and a temperature regulator electrically coupled to the base plate. In some embodiments, the coil may be configured to generate and transmit heat, a heating element within the base plate may be configured to generate and transmit heat to the coil, or both the coil and the heating element may be configured to generate and transmit heat. In some embodiments, the coil may be configured to surround a water tube in a wet saw water pan's water filter mechanism, and the present invention may be configured to heat the water within the water tube. In waterproof embodiments, the coil may be configured to heat water not contained in a tube, such as standing water in a wet saw water pan.

### CROSS-REFERENCE TO RELATED APPLICATION

Not applicable.

### TECHNICAL FIELD

The present invention relates generally to the field of portable water heaters and more specifically relates to a wet saw water pan water heater.

### BACKGROUND

Tile installers often use a “wet saw” to cut tile. A wet saw generally consists of a mounted spinning blade that surrounded by a cutting surface. The top half of the blade spins above the cutting surface, and cuts tile. The bottom half of the blade is submerged in a wet saw water pan. As the blade spins through the water, the blade is cleaned and cooled by the water.

Unfortunately, however, cold water in the water pan can be unpleasant for tile installers, particularly if the tile installer has to cut outdoors or in a cold environment. Additionally, tile installers have to prevent the water from freezing so it can be useful. To prevent both freezing water and cold hands, many tile installers change out the cold water for hot water, but such efforts take time and the warm water does not last very long. Therefore, portable water heaters have been developed that heat the water pans. Sadly though, these bucket heaters are poorly configured for wet saw water pans. What is needed therefore is a new wet saw water pan water heater that avoids the challenges and problems associated with known portable water heaters.

Various attempts to solve this problem have been made. One such attempt can be seen with respect to U.S. Pat. No. 9,475,210, incorporated by reference in its entirety herein, which generally discloses a water pumping system for a wet saw. While this disclosure does provide for temperature control of the water in the wet saw's water pan, it is a large system and unwieldy to be hauled around from job site to job site.

Another attempt can be seen with respect to U.S. Pat. No. 8,354,617, incorporated by reference in its entirety herein, which generally discloses a coolant temperature regulation system for a wet saw. While this disclosure does appear to provide for warming “coolant” in a wet saw water pan, this disclosure's complicated electrical system and its proximity to the saw's blade make it an inadequate choice.

Yet another attempt can be seen with respect to U.S. Pat. No. 4,068,116, incorporated by reference in its entirety herein, which generally discloses a type of “bucket heater” suitable for insertion into a water bucket. This disclosure illustrates the incompatibility of typical bucket heaters, which are long and configured to be inserted vertically into a water bucket, and heaters configured to heat water within a wet saw's water pan, which is wide and shallow.

Various attempts have been made to solve the problems which may be found in the related art but have thus far been unsuccessful. A need exists for a new wet saw water pan water heater to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a blade, “fence,” water, etc., are herein meant to include or encompass all equivalents for such elements. For example, in addition to water, any fluid capable of fulfilling the same function is also contemplated by the present invention. Such equivalents are contemplated for each element named in its particular herein.

The present invention relates to a wet saw water pan water heater that overcomes the deficiencies of the prior art. It is contemplated that the present invention may provide a wet saw water pan water heater that quickly and easily heats the water within a wet saw's water pan.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

The features of the invention which are believed to be novel are particularly pointed out and distinctly claimed in the concluding portion of the specification. These and other features, aspects, and advantages of the present invention will become better understood with reference to the following drawings and detailed description.

In some embodiments, the present invention may provide for a wet saw water pan water heater configured to fit inside of a water pan of a commercial wet saw. In some embodiments, the present invention may provide for base plate having at least one coil, in some embodiments three coils, wherein the at least one coil is configured to emit heat at least in the interior of the at least one coil. The at least one coil may be configured to encircle a wet saw's water pump main water line. The at least one coil may also be configured to heat standing water, flowing water, or other water not in a tube.

In some embodiments, the base plate may contain at least one heating element, wherein the at least one heating element is configured to generate heat and transmit the heat to the at least one coil. In some embodiments, either the at least one coil or the at least one heating element may generate heat. In some embodiments, both the at least one coil or the at least one heating element may generate heat.

In some embodiments, the base place may be electrically coupled, via one or more cables or wires, to a temperature regulator. The temperature regulator, in some embodiments, may provide for a thermometer and/or thermostat such that the temperature regulator is configured to both detect water temperature and adjust the amount of heat emitted by the at least one coil such that the heat emitted by the at least one coil causes the water to heat to a desired temperature.

The base plate, the at least one coil, and/or the temperature regulator may be electrically coupled to a battery, or a power cord, which itself may be electrically coupled to a utility grid, battery, or solar electrical power source. Any battery or solar power system known in the art, particularly those configured for use on job sites, is contemplated by the present disclosure.

The present invention may be configured such that the heat emitted to the inside of the at least one coil heats water as water flows through the wet saw water pump main water line into the pump, whereupon the water pump disperses the water into the wet saw's water pan, against the saw blade, or both.

More specifically, in some embodiments, the present invention may provide for a base plate (or “adaptor”) configured for use with a tube attached to a wet saw water pump's filter, and a heating coil a few inches or longer that loops from one side of the base plate to the other. In some embodiments, the present invention's coils may warm the water when the water pump filter's fan pulls the water through the tubes and then sprays onto the blade while it's being operated. The coil may thus be strategically placed so that the water surrounded stays warm while being pulled into the pump. In some embodiments, the temperature gauge or temperature regulator may be set to a temperature such as but not limited to 75 degrees Fahrenheit, or another temperature that can warm the water without melting the pan.

The unique features of the present invention may provide the following benefits for one or more consumers: it may prevent the water in a wet saw water pan from freezing; and it may provide warm water that is pleasant to the touch for tile installers or other wet saw operators.

### BRIEF DESCRIPTION OF THE DRAWINGS

These and other features, aspects and advantages of the present invention will become better understood with regard to the following description, appended claims, and accompanying figures where:

FIG. 1 shows a top perspective view of a wet saw water pan water heater in accordance with one embodiment of the invention.

FIG. 2 shows a close-up view of an element of a wet saw water pan water heater in accordance with one embodiment of the invention.

FIG. 3 shows a top view of a wet saw water pan water heater as used in one of many configurations in conjunction with a wet saw water pan in accordance with one embodiment of the invention.

### DETAILED DESCRIPTION

The present invention overcomes the limitations of the prior art by providing a new and more effective wet saw water pan water heater

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

In some embodiments, a wet saw water pan water heater may comprise at least one base plate containing at least one heating element, wherein the at least one heating element is configured to generate and transmit heat; at least one coil electrically coupled to the at least one base plate, wherein the at least one coil is configured to receive the heat from the at least one heating element; at least one power source configured to deliver electrical power to the at least one heating element; and at least one temperature regulator electrically coupled to the at least one base plate, wherein the at least one temperature regulator is configured to control the heat produced by the at least one heating element.

In some embodiments, the at least one coil may be configured to surround at least one water tube, wherein the at least one water tube is configured to deliver water to at least one wet saw water pump. In some embodiments, the at least one coil may comprise three coils. In some embodiments, the temperature regulator may further comprise at least one temperature indicator and an on/off button. In some embodiments, the temperature regulator may be configured to cause the coil to heat the water to a constant temperature over time.

In some embodiments, the at least one power source may be an electrical cord configured to deliver (or conduct) electricity that has its source in the utility power grid, a battery, or a solar power source. In some embodiments, the at least one power source may be a battery.

In some embodiments, a wet saw water pan water heater may comprise at least one base plate; at least one coil electrically coupled to the at least one base plate, wherein the at least one coil is configured to generate heat; at least one power source configured to deliver electrical power to the at least one coil; and at least one temperature regulator electrically coupled to the at least one base plate, wherein the at least one temperature regulator is configured to control the heat produced by the at least one coil.

In some embodiments, the at least one coil may be configured to surround at least one water tube, wherein the at least one water tube is configured to deliver water to at least one wet saw water pump. In some embodiments, the at least one coil may comprise three coils. In some embodiments, the temperature regulator may further comprise at least one temperature indicator and an on/off button. In some embodiments, the temperature regulator may be configured to cause the at least one coil to heat the water to a constant temperature over time.

In some embodiments, the at least one power source may be an electrical cord configured to deliver (or conduct) electricity that has its source in the utility power grid, a battery, or a solar power source. In some embodiments, the at least one power source may be a battery.

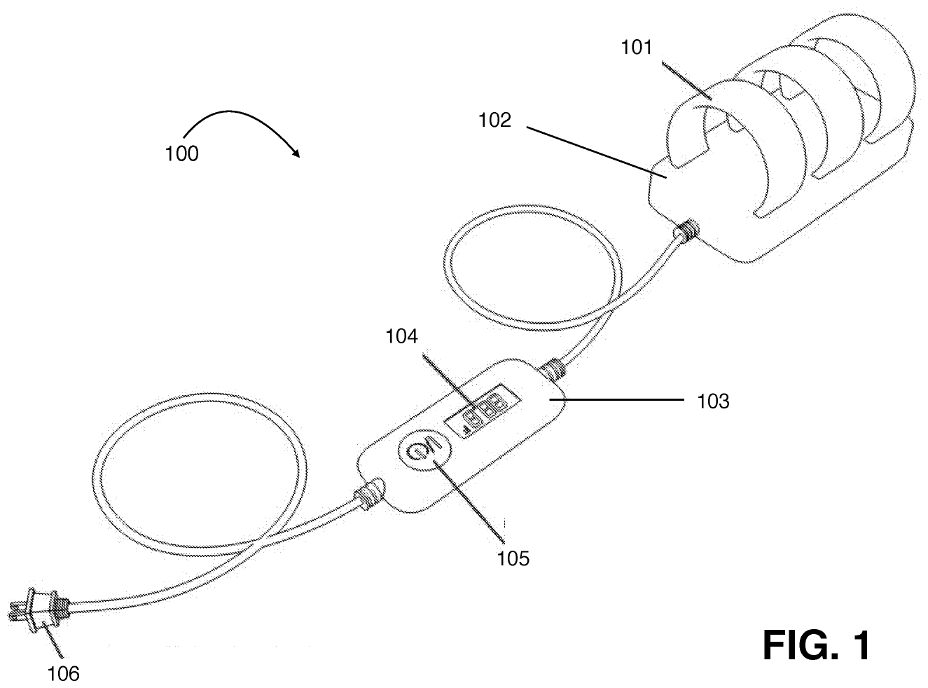

Turning attention to FIG. 1, top perspective view of a wet saw water pan water heater in accordance with one embodiment of the invention is shown. In the embodiment depicted, a viewer may perceive wet saw water pan water heater 100, coil 101, base plate 102, temperature regulator 103, temperature indicator 104, on/off button 105, and electrical cord 106.

In some embodiments, one, two, three, or more, coils 101 may be provided. Additionally, coil 101 may be or larger or smaller circumference than depicted in FIG. 1. It is contemplated that the width, thickness, and other properties of coil 101 may be larger or smaller than depicted in FIG. 1. It is thus contemplated that any number or configurations of coil 101, along with any diameter, thickness, spacing, or other arrangement of any number of coil 101, is contemplated in order to enable or configure coil 101 to surround a water tube and heat water within the tube. For example, in embodiments, where the water tube is of a certain diameter and the walls of the tube are of a certain thickness, coil 101 may be of a matching or compatible diameter, may be configured to emit a certain amount of heat, and a sufficient number of coil 101 may be provided to heat the water within the tube. Additionally, coil 101 may be comprised of any substance capable of conducting heat, such as but not limited to, metal, ceramic, or any other substance known in the art to conduct heat.

Base plate 102 may, in some embodiments, contain a heat-generating element that is capable of converting electrical power or energy to thermal power or energy, and transferring heat to coil 101. As well, base plate 102 may be comprised of any substance, including but not limited to metal, plastic, ceramic, or other element known in the art. In some embodiments, base plate 102 may be waterproof. In some embodiments, base plate 102 may be of any thickness, size, or dimensions known in the art, including but not limited to, any dimensions or configurations necessary to adapt to any size or type of tube, house any size or type of heating element, or work with any size wet saw water pan, such as but not limited to water pan 301.

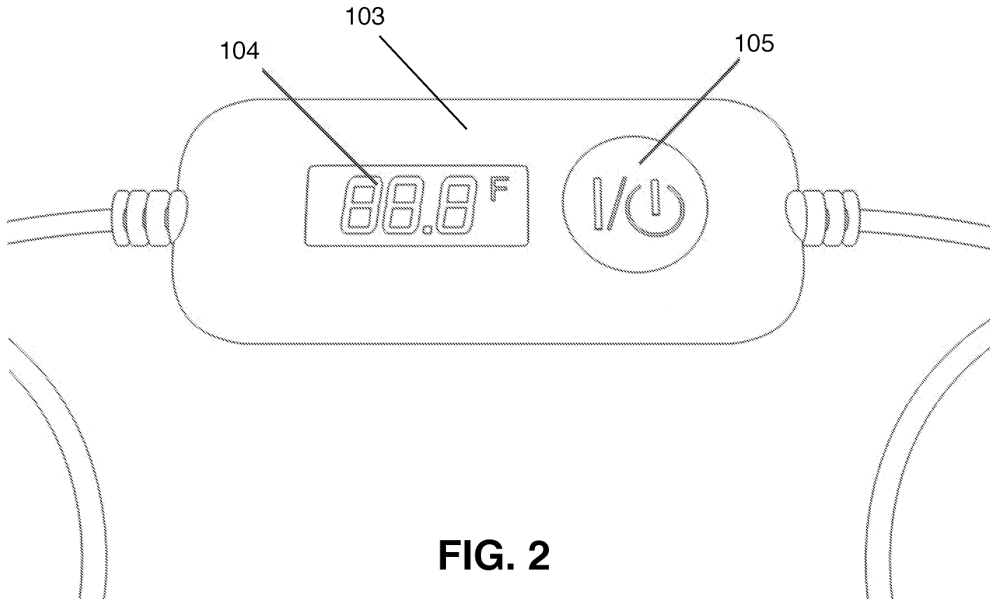

With respect to FIG. 2, a close-up view of an element of a wet saw water pan water heater in accordance with one embodiment of the invention is shown. In the embodiment depicted, a viewer may perceive temperature regulator 103, temperature indicator 104, and on/off button 105.

In some embodiments, temperature regulator 103 may be of any type known in the art, and may correspondingly therefore be of any size or shape, or have any features, known in the art. In some embodiments, temperature regulator 103 may be waterproof. Temperature regulator 103 may also provide for one or more temperature-setting features (not shown) that may enable a user to select a water temperature and may enable temperature regulator 103 to cause base plate 102 to heat coil 101 to a particular setting wherein coil 101 heats such that the water in the tube is heated to a constant or otherwise selected temperature. As well, temperature indicator 104 and on/off button 105 may also be of any type and configuration known in the art.

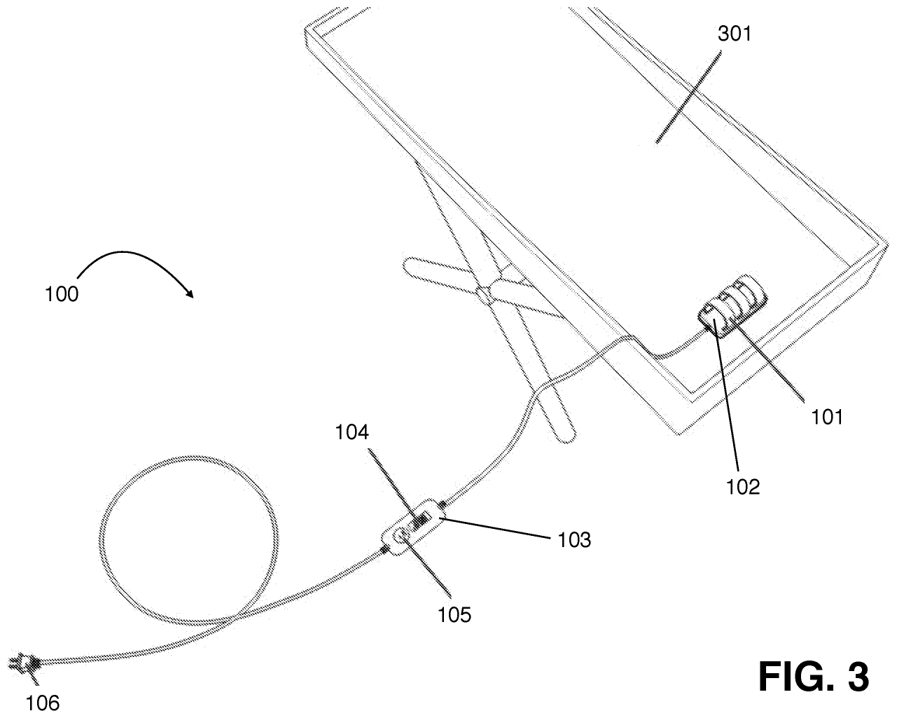

With respect to FIG. 3, a top view of a wet saw water pan water heater as used in one of many configurations in conjunction with a wet saw water pan in accordance with one embodiment of the invention is shown. In the embodiment depicted, a viewer may perceive water pan 301, as well as wet saw water pan water heater 100, coil 101, base plate 102, temperature regulator 103, temperature indicator 104, on/off button 105, and electrical cord 106.

It is contemplated that any size, shape, or configuration of water pan 301 is contemplated. Although not shown in FIG. 3, in some embodiments, a water tube may flow through coil 101 within water pan 301. However, such configuration is not necessarily required. As shown in FIG. 3, wet saw water pan water heater 100 may, in some embodiments, heat standing or flowing water that is not contained in a tube. Therefore, in some embodiments, the present invention may be configured to work with a bucket, a trough, a pond, or any body of water, whether flowing through a tube or not.

### Conclusions, Ramifications, and Scope

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the wet saw water pan water heater generally described herein has been disclosed in connection with a number of embodiments shown and described in detail, various modifications should be readily apparent to those of skill in the art.

What is claimed is:

1. A wet saw water pan water heater, comprising:
at least one base plate containing at least one heating element, wherein the at least one heating element is configured to generate and transmit heat;
at least one coil electrically coupled to the at least one base plate, wherein the at least one coil is configured to receive the heat from the at least one heating element;
at least one power source configured to deliver electrical power to the at least one heating element; and
at least one temperature regulator electrically coupled to the at least one base plate, wherein the at least one temperature regulator is configured to control the heat produced by the at least one heating element.

2. The wet saw water pan water heater of claim 1, wherein the at least one coil is configured to surround at least one water tube, wherein the at least one water tube is configured to deliver water to at least one wet saw water pump.

3. The wet saw water pan water heater of claim 1, further comprising three coils.

4. The wet saw water pan water heater of claim 1, the temperature regulator further comprising at least one temperature indicator and an on/off button.

5. The wet saw water pan water heater of claim 1, wherein the temperature regulator is configured to cause the at least one heating element to heat the water to a constant temperature.

6. The wet saw water pan water heater of claim 1, wherein the at least one power source is an electrical cord.

7. The wet saw water pan water heater of claim 6, wherein the electrical cord conducts electricity that has its source in the utility power grid.

8. The wet saw water pan water heater of claim 6, wherein the electrical cord conducts electricity from a battery.

9. The wet saw water pan water heater of claim 6, wherein the electrical cord conducts electricity from a solar power source.

10. The wet saw water pan water heater of claim 1, wherein the at least one power source is a battery.

11. A wet saw water pan water heater, comprising:
at least one base plate;
at least one coil electrically coupled to the at least one base plate, wherein the at least one coil is configured to generate heat;
at least one power source configured to deliver electrical power to the at least one coil; and
at least one temperature regulator electrically coupled to the at least one base plate, wherein the at least one temperature regulator is configured to control the heat produced by the at least one coil.

12. The wet saw water pan water heater of claim 11, wherein the at least one coil is configured to surround at least one water tube, wherein the at least one water tube is configured to deliver water to at least one wet saw water pump.

13. The wet saw water pan water heater of claim 11, further comprising three coils.

14. The wet saw water pan water heater of claim 11, the temperature regulator further comprising at least one temperature indicator and an on/off button.

15. The wet saw water pan water heater of claim 11, wherein the at least one power source is an electrical cord.

16. The wet saw water pan water heater of claim 15, wherein the electrical cord conducts electricity that has its source in the utility power grid.

17. The wet saw water pan water heater of claim 15, wherein the electrical cord conducts electricity from a battery.

18. The wet saw water pan water heater of claim 15, wherein the electrical cord conducts electricity from a solar power source.

19. The wet saw water pan water heater of claim 11, wherein the at least one power source is a battery.

20. The wet saw water pan water heater of claim 11, wherein the temperature regulator is configured to cause the coil to heat the water to a constant temperature
